(19) United States
(12) Patent Application Publication
(10) Pub. No.: US 2005/0172152 A1
(43) Pub. Date: Aug. 4, 2005

(54) Method and system for a trusted transducer

(76) Inventor: David E. Orr, Vancouver, WA (US)

Correspondence Address: David E. Orr, 4619 NE 39th Avenue, Vancouver, WA, 98661-2508, US

(21) Appl. No.: 10/864,091

(22) Filed: Jun. 8, 2004

Related U.S. Application Data
(63) Continuation-in-part of application No. 10/769,975, filed on Feb. 2, 2004.

(51) Int. Cl. G09C 3/00

(52) U.S. Cl. 713/201

(57) ABSTRACT

An encoder-decoder is disclosed for embedding digital rights meta-data onto digital media, such as images, documents and sound. The encoder-decoder uses a cryptographic. key to control encoding and decoding. For example, in encoding, the cryptographic key controls a cryptographic embedding of a meta-data onto the media so that the message cannot be extracted from the media, unless one has a private key.

### RELATED APPLICATIONS

This Application is a Continuation-in-Part of U.S. application Ser. No. 10/769,975, entitled METHOD AND SYSTEM FOR A TRUSTED TRANSDUCER, filed on Feb. 2, 2004, and which is incorporated herein by reference.

### FIELD OF THE INVENTION

Various aspects of this invention pertain to controlling and securing the rights to the contents or interpretations of signals. More particularly, all these aspects relate to techniques for embedding meta-data into transmissions or signals, whereby meta-data is embedded and extracted according to a cryptographic key. One embodiment of the device and method disclosed herein permits meta-data to be steganographically embedded in transmissions according to a public cryptographic key in which the steganographic parameters are published, and wherein the steganographic meta-data can only be detected by use of a private key.

By controlling parameters the device and method can be made to create transmissions with embedded meta-data, with the digital media having varying quality for reproduction, depending upon embedding parameters. By proper selection of embedding parameters, quality can be varied from an imperceptible embedding to an embedding in which quality is compromised to the point where meta-data occludes features of the digital media.

### BACKGROUND

Reliable and economical methods for incorporating and detecting meta-data within signals are attractive for many applications. Meta-data is used, for example, to embed copyright data in music or other types of audio signals. The presence of embedded meta-data in a suspect signal would make unauthorized use of that signal easy to demonstrate. Or, meta-data could indicate the serial number of all audio signal intended for broadcast, controlling the number of times the signal is broadcast automatically.

Another possible application is in assurance of content integrity. The meta-data may be a string of identification tags placed throughout a host signal. Periodic checking of the encoded meta-data for modified or missing tags would reveal whether the signal has been modified or clipped since encoding. In other applications, meta-data could include augmentation data, such as caller identification in telephone transmissions; product identification in radio broadcasts, for example, song name, performer, recording; or closed-captioning of television signals.

In the control of sensitive documents, meta-data embedded into a document could indicate the conditions under which the document could be viewed, distributed or printed. Computer systems, and associated printing mechanisms could analyze meta-data that was steganographically embedded into the document before permitting the document to be printed or sent out into a network.

Known approaches to incorporating such information have emphasized introducing meta-data in a form that is not perceivable by the human auditory or visual systems. But, hiding data imperceptibly in audio signals is especially challenging for several reasons. The human auditory system operates over a wide dynamic range and can detect signals of strengths falling in a range greater than one billion to one. The human auditory system can also perceive frequencies over a range wider than one thousand to one. Its sensitivity to additive random noise is also acute. Perturbations as small as one part in ten million (80 dB below ambient level) in an audio string can be detected by the human auditory system.

Therefore data hiding, or steganography, has developed as a class of well-specified processes, in many cases—published algorithms that are used to embed recoverable meta-data. These meta-data are embedded in digitally represented information, such as a host signal, with minimal perceivable degradation to the host information. Using various approaches, changes are introduced by embedding meta-data that may be perceivable by a human, as long as they are not conspicuous or objectionable. The goal of data hiding is not to restrict access to the host information, but rather to distribute embedded meta-data along with the host information. The ability to embed meta-data inconspicuously makes data hiding attractive for adding information to host signals.

It is anticipated that after incorporating meta-data, the encoded signal will undergo degradation by intentional manipulation and inadvertent modification due, for example, to channel noise, filtering, re-sampling, editing, clipping, lossy compression, or digital-to-analog/analog-to-digital conversion. in order to be effective, the data hiding technique should embed meta-data in a manner that allows determination of its presence or absence even after such signal modifications. This requirement limits the utility of introducing embedded meta-data in a manner that is not perceived by the human auditory system at all, for example, as noise, since lossy data compression algorithms tend to remove such imperceptible or nonessential elements from the signal.

Other requirements of the meta-data embedding technique depend on the nature and intended use of the embedded information. For example, if the meta-data contains copyright information, it is especially important the technique be resistant to attempts by an unauthorized user to obscure or eliminate the embedded meta-data, therefore meta-data embedding must be resistant to “hacking” by those wishing to remove information for the purposes of pirating the host signal. In many cases the nature and method of meta-data embedding is publicly documented in the form of technical specifications or patents; therefore techniques for removing embedded meta-data become widely known quickly, making it desirable to have some means of hiding or obscuring the nature and method of the embedding.

What is needed is a mechanism—such as a public cryptographic key—to control embedding so that a system can embed meta-data in such a way that the meta-data cannot be detected, or extracted, except by a process which uses the private key associated with the public key.

### SUMMARY

The various aspects of the invention that are disclosed assume an encoder and a decoder exchanging digital media. The digital media are used to modulate a signal according to well-established principles of transmission systems methods and techniques. The encoder embeds meta-data into the digital media by a sequence of transformations on the digital media according to the meta-data. The encoder sends the digital media with embedded meta-data to the decoder. The decoder applies inverse transformations to extract the meta-data.

The embedding algorithm, structure of the meta-data fields embedded, and embedding parameters are assumed to be public information. Therefore various aspects of the invention use cryptography to either hide the content of the meta-data field or to control the algorithms that map meta-data to digital media content.

Therefore in recognition of the need for an encoding device that will encode or embed a meta-data into digital media using cryptographic means, herein is disclosed, in various aspects of the invention, an encoding device having a cryptographic key, for embedding meta-data into digital media, the device comprising a plurality of transformation components for embedding the meta-data into the digital media, wherein one of the transformation components uses a cryptographic key.

The meta-data embedded digital-media are employed to modulate a carrier, or may be transmitted as base-band signals by a transmitter, and are decoded at a receiver.

Other aspects of the invention are also disclosed in terms of a decoding device, in a computer system having a cryptographic key, for extracting meta-data embedded from digital data, the device having a plurality of transformation components, wherein one of the transformation components uses a cryptographic key.

These aspects are disclosed describing an encoder that steganographically embeds meta-data into the digital data, and a decoder, which extracts steganographic meta-data from the digital data.

It will be seen that the disclosure describes different aspects of an invention that comprise an encoder and a decoder employing a product of transformations of digital media according to meta-data to be embedded or extracted.

A common element to all these aspect is that one of these transformations is a transformation according to a cryptographic key. Therefore the disclosed aspects of the invention require embedding meta-data according to an encryption key, and extracting meta-data requires decryption according to the inverse key.

One aspect is disclosed describing encoding according to a public cryptographic key and decoding according to a private cryptographic key.

And, yet another aspect is disclosed with encoding and decoding performed according to a key computed from an elliptic curve crypto-system.

It will be appreciated that the various aspects of the invention provide numerous advantages to a user of the disclosed invention, among these being that meta-data is embedded according to a public cryptographic key, and meta-data is extracted according to a private cryptographic key.

A second advantage is that actual meta-data embedding and extraction process uses well-known cryptographic algorithms, such as RSA or elliptic curve algorithms.

A third advantage is that the meta-data is easily determined from the embedding given the encryption system.

These advantages and other advantages and benefits will become obvious in the following detailed description.

### BRIEF DESCRIPTION OF THE DRAWINGS

FIG. 1 depicts the decomposition of digital media into some representation such as performing a discrete cosine transform- or JPEG encoding.

FIG. 2a illustrates the process of using the public encryption key to encrypt meta-data before embedding.

FIG. 2b depicts the embedding process, wherein selected coefficients of the decomposed digital, media are changed according to the encrypted meta-data.

FIG. 3 shows the system and method of the invention applied to mapping the discrete-cosine transform (DCT) of a set of data.

FIG. 4 illustrates the process of using the embedding parameters to embed meta-data onto digital media.

FIG. 5a shows an embedding of meta-data using a product of mappings.

FIG. 5b shows the use of a cryptographic key to embed meta-data.

### DETAILED DESCRIPTION

The present invention is disclosed in various exemplary aspects, all of which are practiced on a computer system having a CPU, memory, and input-output devices. The CPU is assumed to be a digital processor that is programmed with algorithms compiled in the C, C++, Java, Visual BASTC languages, or an assembly language that is native to the CPU used. Algorithms used to practice various aspects of the invention may also be micro-coded or implemented as ASICs (application specific integrated circuits) or FPGA (field-programmable gate-arrays.) Memory is used to store the algorithms while they execute. Input-output devices, such as a disk drive, provide persistent storage for the algorithms, and provide the means whereby the algorithms can be loaded for execution. Implementation of various aspects of the invention may require the computer system to communicate with a remote computer system in order to receive data—in the form of a public encryption key—and to transmit data—in the form of the embedded digital—media and embedding parameters. Otherwise a public key can be provided manually and the embedded data plus embedding parameters can be transferred to removable media for manual transport.

A First Aspect of the Invention

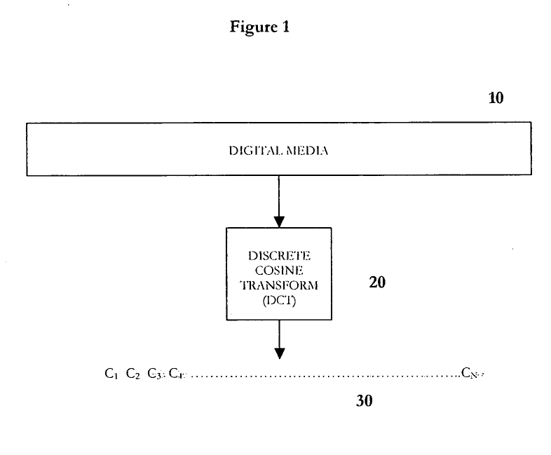

FIG. 1 digital media is first decomposed using an algorithm such as a discrete-cosine transform (DCT). Examples of DCT-based transforms include the well-known JPEG, MPEG and the MP3 algorithms. Digital media in the form of sound, images and even ASCII or EBCDIC coded digital documents are examples of media that can be decomposed using DCT-based algorithms. As is well known, the coefficients that are derived by the DCT-algorithms form the basis of the representation for the DCT. These coefficients can be subjected to further analysis and, based upon this analysis, can be set to zero or eliminated. The result of this, of course, is so-called “lossy” compression. It is well known that high-quality lossy compression is based upon a high-degree of correlation in the digital media, with lossy compression for ASCII coded documents obviously being problematic.

Using the DCT and its variations, FIG. 1 digital media 10 is decomposed by a discrete-cosile transform, or DCT 20 into sets of transform coefficients 30, which suffice as the representation of the digital media in the transform domain.

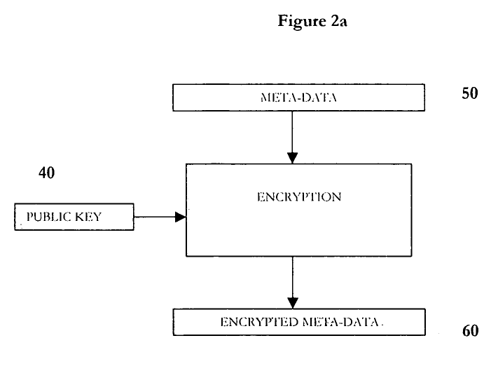

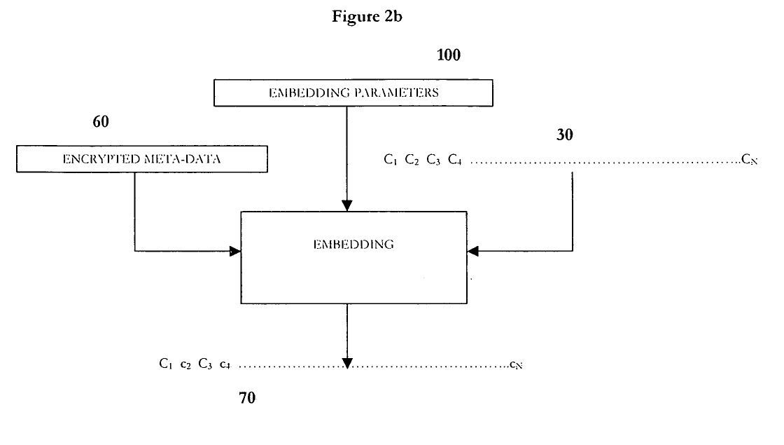

FIG. 2a using a public encryption key 40, the embedding mechanism encrypts the meta-data 50 before embedding. FIG. 2b the encrypted meta-data is used to modify DCT coefficients 30 and derive a set of modified DCT coefficients 70. A set of embedding parameters, FIG. 2b 100 is used to map encrypted meta-data 60 onto the digital media, more specifically the embedding parameters in this aspect of the invention are used to modulate or modify certain of the DCT coefficients 30 in order to embed meta-data.

Meta-data is encoded in terms of a binary alphabet, wherein meta-data coding is expressed in an alphabet of ‘0’ and ‘1’. Meta-data is encoded using the well-known ASCII or EBCDIC codes, each of which uses pattern composed of the binary alphabet. Other well-known codes may also be used, so long as the representation is comprised of binary elements of ‘0’ and ‘1’.

Each bit of encrypted meta-data is used to modify a DCT coefficient that is selected for embedding; the DCT coefficient selected so that a human perceiver will not detect its modification.

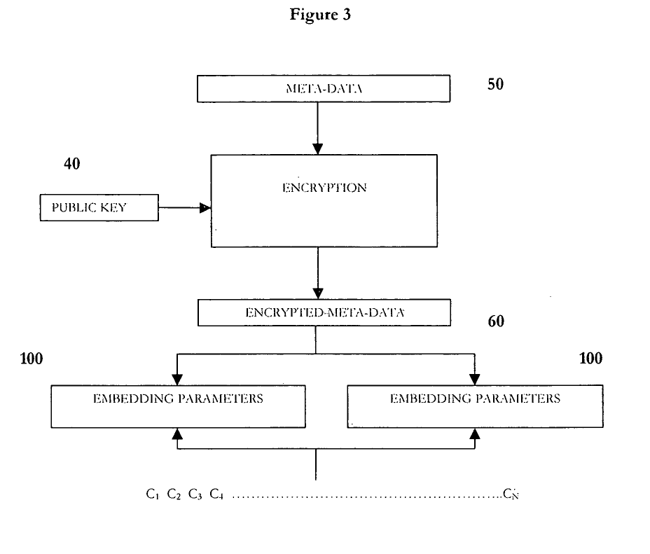

Embedding is comprised of a product of mappings FIG. 3: (1) each element of a meta-data string 50, M, expressed in an alphabet of ‘0’ and ‘1’ is mapped to an element of a second string 60, M, of ‘0’ and ‘1’; (2) each element, or bit, of M is mapped to one of two sets of embedding parameters 100, P, and; (3) a DCT coefficient 70, Cₖ, of the decomposition is then mapped to P by replacing the coefficient with the embedding parameter.

The mapping FIG. 3 of M to M is a cryptographic mapping using the public cryptographic key. The meta-data string is mapped to a second meta-data string using a public cryptographic key that is provided to the encoder. Therefore the sequence of binary values comprising M is mapped to a different string of binary values that represent M.

FIG. 3 embedding parameters 100 comprise two sets; one set corresponds to a binary ‘0’ and one set corresponds to a binary ‘1’. For example, assume that a binary ‘0’ corresponds to the set {1, 5, 11, 17, . . . } and a binary ‘1’ corresponds to the set {3, 7, 13, 9, . . . }. While this example uses prime numbers for embedding parameters, neither this aspect nor any other aspect of the invention requires the use of prime numbers as embedding parameters.

FIG. 3 M is mapped to P according to the binary value of M. If the element of M is a ‘0’ then the set of elements of P that correspond to ‘0’ is selected. In this case if the element of M is a ‘0’, then the mapping is represented, for example, by the set of embedding parameters: {1, 5, 11, 17, . . . }. If the element of M were a ‘1’, the mapping is represented, for example, by the set {3, 7, 13, 19, . . . }.

FIG. 3 the DCT coefficient 70 C is mapped to P according to: (1) the set representing the mapping from M to P is examined; (2) the element in the mapping that is closest in absolute value is selected and C is changed to that value.

As an example, assume that the element of M that is embedded is ‘1’. The mapping of M to P is the set {3, 7, 13, 17 . . . }. Assume the DCT coefficient that will be changed by the embedding is ‘11’. Since ‘13’ is closest in an absolute sense, the DCT coefficient is changed to ‘13’.

The composite mapping of the meta-data to the DCT coefficients is continued until all meta-data alphabet values have been impressed onto the digital media.

The decomposed digital data with embedded meta-data is then either (1) sent directly to, or stored for the later use of, the decoder device for the purpose of extracting meta-data and controlling the use of the digital media, or; (2) re-composed, then stored or sent. The digital media is re-composed or re-constituted by performing the inverse DCT using coefficients that have been modified by embedding.

The set of DCT coefficients that are chosen to modify or modulate depends upon the effect that modulation will have on a human perceiver. Therefore, the set of DCT coefficients will be chosen by ‘psycho-perceptual analysis’ using well-known and well-understood principles that are employed in steganographic embedding of meta-data in music and images.

When received by the decoder the digital media, with embedded meta-data, is processed by ‘inverting’ the composite mapping. Assuming the received digital media has been decomposed, the decoder: (1) scans the DCT coefficients looking for elements of the mapping M to P; (2) concatenates each element of the mapping into a string of ‘0’ and ‘1’; (3) apply the private cryptographic key to the string of ‘0’ and ‘1’to yield the meta-data string M.

As an example, if the set of DCT coefficients examined were 3, 11, 13, 1, 5, then according to the mapping of M to P: (1) ‘3’ is derived-from mapping ‘1’; (2) ‘11’ is derived from mapping a ‘0’; (3) ‘13’ is derived from mapping a ‘1’; (4) ‘1’ is derived from ‘0’, and; (5) ‘5’ is derived from ‘0’. Therefore M is the binary string: ‘10100’. Since the mapping from M to M is inverted by applying the private cryptographic key, the private decryption key is applied to M and M is derived.

The process of examining DCT coefficients depends upon the set selected for examination. Since DCT coefficients were chosen for embedding using ‘psycho-perceptual’ analysis, the same analysis is applied at the decoder.

A Second Aspect of the Invention

In the second aspect, digital media is first decomposed using a wavelet transform. Wavelet-based transforms have been used for a number of years and there is a rich literature on algorithms and methods for applying wavelet transforms. Digital media in the form of sound, images and even ASCII or EBCDIC coded digital documents are examples of media that can be decomposed using wavelet-based algorithms. As is well known, the coefficients that are derived by the wavelet transform form the basis of the wavelet representation. These coefficients can be subjected to further analysis and, based upon this analysis, can be set to zero or eliminated. The result of this, of course, is so-called “lossy” compression. It is well known that high-quality lossy compression is based upon a high-degree of correlation in the digital media, with lossy compression for ASCII, coded documents obviously being problematic.

Using the wavelet transform digital media is decomposed into data sets of transform coefficients, which now suffices as the representation of the digital media in the wavelet transform domain.

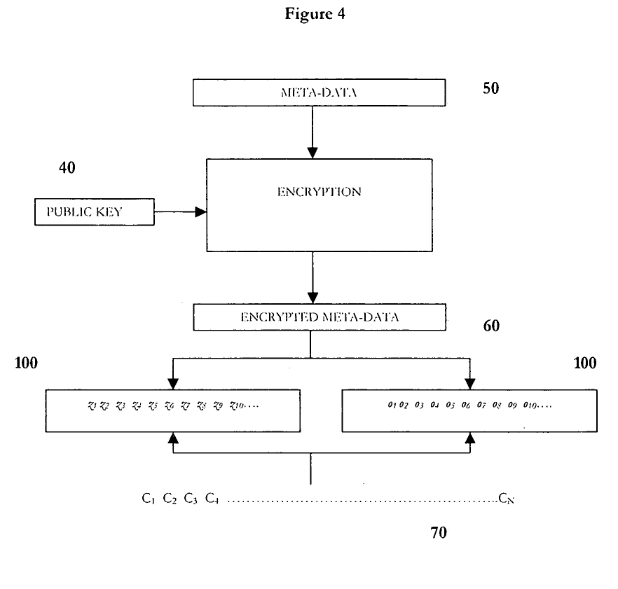

A set of embedding parameters, FIG. 4 100 is used to map meta-data 50 onto the digital media, more specifically the embedding parameters are used to modulate or modify certain of the wavelet transform coefficients 70 in order to embed meta-data.

Meta-data is encoded in terms of a binary alphabet, wherein meta-data coding is expressed in an alphabet of ‘0’ and ‘1’. Meta-data can be encoded using the well-known ASCII or EBCDIC codes, each of which uses pattern composed of the binary alphabet.

Embedding is comprised of a product of mappings FIG. 4: (1)each element of a meta-data string, M, expressed in an alphabet of ‘0’ and ‘1’ is mapped to an element of a second string, M, of ‘0’ and ‘1’; (2) each element of M is mapped to one of two sets of embedding parameters, P, and; (3) a wavelet coefficient, W, of the decomposition is mapped to P.

The mapping FIG. 4 of M to M is a cryptographic mapping using the public cryptographic key. As in the case of the first aspect, the public key can be derived using any of the well-known algorithms; in this aspect of the invention the encoder uses a public key derived by an elliptic curve algorithm.

FIG. 4 M is mapped to P. If the element of M is a ‘0’ then all the elements of P that correspond to ‘0’ are selected. In this case if the element of M is a ‘0’, then the mapping is represented by the set {z₁,z₂z₃ . . . }. If the element of M were a ‘1’, the mapping is represented by the set {o₁,o₂, o₃. }.

FIG. 4 the wavelet coefficient W is mapped to P according to: (1) the set representing the mapping from M to P is examined; (2) the element in the mapping that is closest in absolute value is selected and C is changed to that value.

As an example, assume that the element of M that is embedded is ‘1’. The mapping of M to P is the set {o₁,o₂,o₃ . . . }. Assume the wavelet coefficient that will be modulated by the embedding is ‘107’, and that oₖ is equal to ‘109’, and is closest in an absolute sense to ‘107’; therefore the wavelet coefficient is changed to ‘109’.

The composite mapping of the wavelet coefficients according to the meta-data is continued until all meta-data alphabet values have been impressed onto the digital media.

In addition to meta-data embedded by modulating wavelet coefficients, additional binary values are also impressed by modifying wavelet coefficients. These additional binary values comprise ‘error-correcting’ codes that are used by the decoder to correct errors that are caused by distortions in the digital media and to confirm meta-data is being interpreted correctly. Error-correcting encoding using Hamming codes or Reed-Solomon encoding is used by the encoder to provide a means for the decoder to verify and error-correct meta-data derived from decoding wavelet coefficients.

The decomposed digital media with embedded meta-data is then either (1) sent directly to, or stored for the later use of, the decoder device for the purpose of extracting meta-data and controlling the use of the digital media, or; (2) re-composed, then stored or sent. The digital media is re-composed or re-constituted by performing the inverse wavelet transform using coefficients that have been modified by embedding.

The set of wavelet coefficients that are chosen to modify or modulate depends upon the effect that modulation will have on a human perceiver. Therefore, the set of, wavelet coefficients will be chosen by ‘psycho-perceptual analysis’ using well-known, and well-understood principles that are employed in steganographic embedding of meta-data in music and images.

When received by the decoder the digital media, with embedded meta-data, is processed by ‘inverting’ the composite mapping. Assuming the received digital media has been decomposed, the decoder: (1) scans the wavelet coefficients looking for elements of the mapping M to P; (2) concatenate-each element of the mapping into a string of ‘0’ and ‘1’; (3) apply the elliptic curve private cryptographic key to the string of ‘0’ and ‘1’ to yield the meta-data string M.

As an example, if the set of wavelet coefficients examined were o₅, z₁₂, o₂₇, z₄₇, then according to the mapping of M to P according to V: (1) o₅ is derived from mapping ‘1’; (2) z₁₂ is derived from mapping a ‘0’; (3) o₂₇ is derived from mapping a ‘1’, and; (4) z₄₇ is derived from ‘0’. Therefore M is the binary string: ‘1010’. Additional wavelet coefficients are similarly derived and analyzed to perform error-correction on the meta-data string extracted.

Since the mapping from M to M is inverted by applying the private cryptographic, key, thus M is derived.

The process of examining wavelet coefficients depends upon the set selected for examination. Since wavelet coefficients were chosen for embedding using ‘psycho-perceptual’ analysis, the same analysis is applied at the decoder.

A Third Aspect of the Invention—an Overview

A third aspect of the invention is disclosed with a different mapping, but also using a cryptographic key, that is, the set of coefficients, whether DCT coefficients or wavelet transform coefficients are mapped to the embedding parameters according to meta-data using a product of mappings, wherein one of the mappings is a mapping using a cryptographic key.

In this aspect of the invention, embedding parameters used by the embedding algorithm are determined by a cryptographic mapping.

Using well-known psycho-perceptual methods a set of coefficients {C} is selected for embedding. The number of elements in {C} is equal to the number of bits that are required to represent meta-data to be embedded, or, additional coefficients can be selected for embedding error-correcting bits that are appended to and correct meta-data. The following paragraphs describe the process for mapping the embedding parameters to the set {C} according to the bit representation of the meta-data.

In this aspect of the invention meta-data is mapped to digital media by a product of four mappings: (1) the second mapping, V, of the plurality of mappings interchanges elements among two sets of embedding parameters, where V is encrypted as V′ and received from the decoder, which is assumed to not be co-located with the encoder, although this assumption is not relevant to this aspect the invention; (2) the first mapping of the plurality of mappings uses a cryptographic key to map V′ to V, which is a different interchange of elements among the two sets of embedding parameters; (3) meta-data is mapped to embedding parameters by selecting one of two sets of embedding parameters after V has been applied to two original sets of embedding parameters; (4) a coefficient is mapped to an embedding parameter by finding, in the set selected by the meta-data mapping, that element that is closest, in absolute value, to the coefficient.

Details of the Third Aspect

The encoder has two sets of embedding parameters, one set E_{z} corresponding to a binary value of ‘0’ in the meta-data string, and a second set Eₒ corresponding to a binary value of ‘1’ in the meta-data string. The second mapping in the product of mappings is the mapping V, which maps the two sets E_{z} and Eₒ to the two sets E′_{z} and E′ₒ. The first mapping is a mapping of V′ to V using a cryptographic key.

The third mapping is a mapping of each of the binary elements of the meta-data, string to one of the sets E′_{z} or E′ₒ depending upon whether the binary element is a ‘0’ or a ‘1’.

The fourth mapping is a mapping of a selected DCT or wavelet coefficient to one, element of the embedding parameter set selected by the third mapping. The fourth. mapping is defined by (a) given a DCT or wavelet coefficient C and the set of embedding. parameters selected by the third mapping; (b) find that element of the set of embedding parameters selected by the third mapping that is closest to C in absolute value. If two embedding. parameters are equally close to C, in absolute value, the smallest embedding parameter is selected; (c) C is replaced: by the selected embedding parameter.

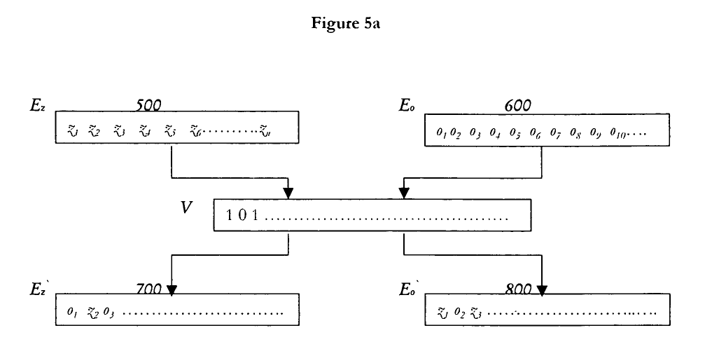

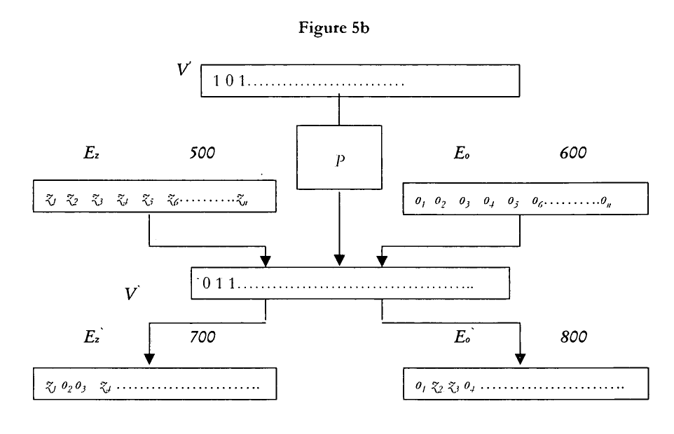

An example of embedding comprised of a product of mappings is shown in FIG. 5a: (1), each element of a meta-data string, M, is expressed in terms of an alphabet of ‘0’ and ‘1’; (2) a binary ‘0’ in the meta-data string corresponds to a set of embedding parameters E_{z} FIG. 5a 500, and a binary ‘1’ corresponds to a second set of embedding parameter Eₒ FIG. 5a 600. The two sets of embedding parameters have the same number of elements and have no elements in common; (3) the mapping V that exchanges elements between the two sets E_{z} 500 and Eₒ 600 is shown.

The mapping V is expressed in terms of a binary string having the same number of elements as each of the two sets of embedding parameters 500 and 600. The mapping is defined for each element j of 500, 600 and V: (a) if the j'th element of V is a binary ‘1’, exchange the j'th element of 500 and 600, otherwise; (b) do not exchange the j'th element. Therefore given 500, 600 and V as shown in FIG. 5a, the sets are mapped as shown, that is (a) Eₒ={o₁, o₂, o₃, o₄, . . . } is mapped to E′ₒ={o₁, z₂, z₃, o₄, . . .} and E_{z}={z₁, z₂, z₃, z₄, . . . } mapped to E′_{z}={z₁, o₂, o₃, z₄, . . . }. Therefore the second mapping in the product of mappings is defined by V, which exchanges elements of the two sets of embedding parameters.

The cryptographic key, P, FIG. 5b maps V to V′. Since V′ is a string of binary elements-‘0’ and ‘1’, the cryptographic key maps V to a different string of ‘0’ and ‘1’. The inverse cryptographic will invert the map and yield V. FIG. 5b using the cryptographic key the binarystring representing V=1101 . . . is mapped to 0110 . . . .

Therefore one of the transformations of the plurality of transformations maps V′ to V using a cryptographic key: (1) both the encoder and decoder have the same sets of embedding parameters, E_{z} and Eₒ; (2) the decoder computes or creates V, then uses the encoder's public encryption key to compute V′ and sends V′ to the encoder; (3) the encoder applies its private key as a transformation on V′ to derive V and uses the transformation V on E_{z} and Eₒ to derive E′_{z} and E′ₒ then employs E′_{z} and E′ₒ to embed meta-data into the digital media; (4) the encoder sends digital media with embedded meta-data and to the decoder; (5) since the decoder has V and the same set of embedding parameters as the encoder it can extract meta-data from the digital media.

The third mapping is defined as: for each binary element of the meta-data string; (a) if the binary element is a ‘0’; select the set of embedding parameters E′_{z}, otherwise; (b) select E′ₒ. Therefore for the elements of V′=01010 . . . 0, the embedding parameter sets that are selected are E′_{z}, E′ₒ, E′_{z}, E′ₒ, E′_{z} . . . , E′_{z}.

The fourth mapping of the product of mappings is defined by: for each of the selected coefficients Gₖ and the k'th set of embedding parameters selected by the third mapping; find the element of the k'th set that is closest in absolute value to Gₖ. Replace Gₖ by the element selected from the set of embedding parameters. If two elements have the same absolute difference with Gₖ, the smallest element is selected.

The decomposed digital media with embedded meta-data is then either (1) sent directly to, or stored for the later use of, the decoder device for the purpose of extracting meta-data and controlling the use of the digital media, or; (2) the digital media with embedded meta-data is re-composed, then stored or sent to the decoder. The digital media is re-composed or re-constituted by performing the inverse DCT or wavelet transform using coefficients that have been modified by embedding before sending to the decoder.

When received by the decoder, digital media with embedded meta-data is processed by ‘inverting’ the composite mapping. Since the decoder has V; the decoder sent V to the encoder encrypted as V′, and has the embedding parameters, E_{z} and Eₒ, the decoder will apply V to E_{z} and Eₒ, to derive E′_{z} and E′ₒ.

The decoder: (1) decomposes the received digital media into sets of coefficients using the transform applied by the encoder; (2) scans wavelet coefficients, according to the same psycho-perceptual principles applied by the encoder, looking for elements of the mapping M to P according to V; (2) derives the meta-data binary element from the mapping and concatenates each element of the mapping into a string of ‘0’ and ‘1’ to yield the meta-data string M.

As an example, assume a meta-data string, 0101 is to be embedded onto digital media, and that V is 1010. When the public encryption key is applied, V is mapped to V′, which is 0110. V′ is sent to the encoder by the decoder using the encoder's public cryptographic key. The encoder applies its private cryptographic key to V′ to derive V.

Given {z₁, z₂, z₃, z₄} and {o₁, o₂, o₃, o₄}; and applying V, the encoder derives the embedding parameter sets {z₁, o₂, o₃, z₄} and {z₁, o₂, z₃, o₄}. The meta-data string is embedded by the encoder by selecting coefficients, which are replaced by the embedding parameters to yield {z₄, o₂, o₃, z₁} as the coefficients modulated by meta-data.

The encoder re-constitutes the digital media using the replaced coefficients and sends all to the decoder.

Decoding according to V, the decoder will derive the exact same sets of embedding parameters {o₁, z₂, o₃, z₄} and {z₁, o₂, z₃, o₄} that were used by the encoder. According to this set of embedding parameters, the coefficients that were replaced by embedding parameters and received by the decoder; {z₄, o₂, o₁, z₁}, correspond to the meta-data string 0101.

A Fourth Aspect of the Invention

The fourth aspect of the invention relates to other ways in which embedding parameters are applied to digital media. The process of embedding meta-data into audio signals though the production and insertion of signal “echoes” illustrates this aspect of the invention.

This aspect embeds meta-data into digital audio signal by inserting one or more echoes, or resonances; the attributes of which are determined by encrypted embedding parameters sent by the decoder. Attributes of embedded resonances include; (1) echo time offset from the portion of the host audio signal from which the resonance was derived; (2) amplitude of the resonance; (3) frequency shift of the resonance with respect to the signal, or; (4) frequency band selected for the resonance.

For sufficiently small values of these attributes, the human auditory system interprets an added resonance as a natural resonance due to, for example, interaction of the signal with the walls of a room. Injecting resonances on the order of human vocal tract resonances into the audio signal is generally perceived as natural and considered as an enhancement rather than noise.

To decode the embedded information, the audio signal is checked for resonances having an attribute associated with an embedding parameter. The presence or absence of the resonance with an attribute having an embedding parameter value indicates the presence or absence of meta-data. Any of several well-known techniques known in the art of signal processing may be used for detecting a resonance in the audio signal.

In this aspect: (1) attributes of the resonance and the method of producing the resonance are known to both the encoder and decoder, and are assumed to be publicly available information—what is not publicly known is the manner in which the attributes are modulated by the encoder using embedding parameters; (2) the decoder uses the public cryptographic key of the encoder to encode the sets of embedding parameters E_{z} and Eₒ, then sends the encrypted embedding parameters to the encoder; (3) using its private key, the encoder decrypts E_{z} and Eₒ to yield E′_{z} and E′ₒ; (4) the encoder uses E′_{z} and E′ₒ and meta-data to change the attributes of resonances of the audio signal, and adds the modified resonances back into the audio signal. For example, the encoder will change the phase relationships of the resonances or the amplitudes of the resonances according to meta-data and decrypted embedding parameters, and; (4) after the meta-data is embedded, the encoder sends the audio signal to the decoder.

As an alternative embodiment of the fourth aspect, the embedding parameters may specify a specific attribute of the resonance that is modulated by meta-data, with the modulation fixed and pre-defined. For example, all resonances may be added having a predefined relationship to the audio signal; the embedding parameters specify whether the attribute having the pre-defined relationship is phase or amplitude or a frequency band specified by the sets of embedding parameters. The set of embedding parameters corresponding to a meta-data value of ‘0’ may specify a set of frequency bands for the resonance, while the set of embedding parameters corresponding to a meta-data value of ‘1’ specify a set of resonance amplitudes in a frequency band not specified in the ‘0’ set of embedding parameters.

The decoder has the embedding parameters used by the encoder, so it searches for resonances having characteristics that are predefined and that meet psycho-acoustical requirements. Having found such resonances, the decoder derives meta-data values from attributes of the resonances and according to embedding parameters it has.

Therefore this aspect of the invention relates to a method of embedding meta-data into an audio signal according to the meta-data, and an encrypted message, the method comprising the steps of: (a) receiving encrypted embedding parameters; (b) decrypting; embedding parameters; (c) creating a resonance of the audio signal; (d) selecting an embedding parameter according to the meta-data; (e) changing an attribute of the resonance according to the embedding parameter, and; (f) adding the resonance to the audio signal.

It can be seen that this aspect also describes an encoding device having a cryptographic key, in a computer system, for embedding meta-data into digital media, the device comprising a plurality of transformation components for embedding the meta-data. into the digital media, wherein one of the transformation components uses a cryptographic key.

A Fifth Aspect of the Invention

The fifth aspect of the invention comprises a method of embedding meta-data into a digital document. In this case embedding meta-data directly into the body of the document will destroy information where meta-data is embedded. Therefore, meta-data, must be embedded: (1) as codes that are appended or pre-pended to the text of the document, or; (2) as an “invisible” code that is embedded into the document. By invisible code, it is meant an embedded non-printable character that conveys meta-data information.

For the case of codes that are appended or pre-pended to the text of the document:

For the case of “invisible” codes embedded into the text of the document, the encoder embeds non-printable codes by replacing “white-space” in the text of the document: (1) both encoder and decoder have the two sets of embedding parameters, E_{z} and Eₒ; (2) the decoder computes or creates the transformation V that maps E_{z} and Eₒ to E′_{z} and E′ₒ encrypts V using the encoder's public key and sends V′ to the encoder; (3) the encoder uses its private key to decrypt V, then uses V to transform from E_{z} and Eₒ to E_{z} and Eₒ, and then embeds meta-data replacing document white-space, and; (4) stores or sends the document with embedded meta-data to the decoder. With V, and E_{z} and Eₒ the decoder extracts meta-data from the document's non-printable characters that have replaced white-space.

It can be seen that this aspect also describes an encoding device having a cryptographic key, in a computer system, for, embedding meta-data into digital media, the device comprising a plurality of transformation components, for embedding the meta-data into the digital media, wherein one of the transformation components uses a cryptographic key.

Summary

Therefore, in summary, it can be seen that all aspects of the invention, both the embedding and extraction process is comprised of a product of transformations, one of which is a transformation using a cryptographic key. It will also be obvious to those reading the disclosure that other forms and variations can be chosen to comprise embedding and extracting transformations, but, which are still within the scope of the invention, which is most properly limited by the following claims.

1. An encoding device in a computer system, for embedding meta-data into signals, the device comprising:
a. a plurality of transformation components for transforming signals according to meta-data, and;
b. wherein one of the transformation components is a cryptographic key.

2. An decoding device in a computer system, for extracting meta-data from signals, the device comprising:
c. a plurality of transformation components for transforming signals according to meta-data, and;
d. wherein one of the transformation components is a cryptographic key.

3. An encoding device, in a computer system having a cryptographic key, for embedding meta-data into data, the device comprising:
a. a decomposition component for decomposing the meta-data into sets of data;
b. an embedding component for embedding the meta-data into at least one of the sets of data, wherein the meta-data is embedded according to the cryptographic key.

4. The encoding device of claim 1, wherein the embedding is steganographic.

5. The encoding device of claim 1, wherein the cryptographic key is a public encryption key.

6. The encoding device of claim 1, wherein the cryptographic key is computed from an elliptic curve cryptographic system.

7. A decoding device, in a computer system having a cryptographic key, for extracting meta-data embedded into digital data, the device comprising:
a. a decomposition component for decomposing the digital data into disjoint sets of data;
b. an extraction component for extracting the meta-data embedded into at least one of the disjoint sets of data, wherein the meta-data is extracted according to the cryptographic key.

8. The encoding device of claim 2, wherein the meta-data is steganographically embedded.

9. The decoding device of claim 2, wherein the cryptographic key is computed using an elliptic curve cryptographic system.
